(19) United States
(12) Patent Application Publication
(10) Pub. No.: US 2026/0245772 A1
(43) Pub. Date: Aug. 20, 2026

(54) METHOD FOR ELECTRICALLY INSULATING AN ELECTRICALLY CONDUCTIVE WIRE END OF AN ELECTRICAL WIRE, AND MOUNTING DEVICE FOR FIXING A SLEEVE MADE OF A FLEXIBLE AND ELECTRICALLY INSULATING MATERIAL TO A WIRE END OF AN ELECTRICAL WIRE

(71) Applicant: MERCEDES-BENZ GROUP AG, Stuttgart (DE)

(72) Inventors: Marcel QUINTUS, Nagold (DE); Bernd WEIß, Horb (DE)

(21) Appl. No.: 19/164,795

(22) PCT Filed: Mar. 8, 2024
(86) PCT No.: PCT/EP2024/056244

§ 371 Date: Sep. 12, 2025

(30) Foreign Application Priority Data
Mar. 13, 2023 (DE) 10 2023 000 973.3

(51) Int. Cl. H01B 13/00; H01B 13/06

(52) U.S. Cl. CPC H01B 13/0036; H01B 13/0016; H01B 13/06

(57) ABSTRACT

An electrically conductive wire end of an electrical wire is electrically insulated using a mounting device having a base body with a through opening extending from a first to a second outer side. An end section of a tubular sleeve, made of a flexible and electrically insulating material, is inserted via the first outer side into the through opening and the end section is fixed in the through opening by a fixing element. The fixed end section is separated from the remainder of the sleeve by a cutting tool of the mounting device. The wire end of the electrical wire is inserted via the second outer side into the through opening and the wire end is inserted into the interior of the tubular end section of the sleeve arranged in the through opening. The end section of the sleeve is fixed to the wire end.

### BACKGROUND AND SUMMARY OF THE INVENTION

Exemplary embodiments of the invention relate to a method for electrically insulating an electrically conductive wire end of an electrical wire, preferably in automated fashion, as well as to a mounting device which is designed for carrying out this method.

Single-core or multicore electrical wires—in particular in the form of a so-called electrical end connectors—made of an electrically conductive material usually have an electrically insulating sleeve. However, often the electrically conductive material of the electrical wire is open at its wire end, which makes separate electrical insulation of the wire end necessary for safety reasons.

In this context, it is known that the wire end is provided with an electrically insulating end cap or is wound with an electrically insulating adhesive tape or similar, in order to achieve the desired electrical insulation in this manner.

U.S. Pat. No. 6,090,231 A discloses a method for the automated electrical insulation of an electrically conductive wire end of an electrical wire. For this purpose, a mounting device is provided with a base body having a through opening. An end section of a tubular, electrically insulating sleeve is introduced into the through opening and is fixed in the through opening by means of fixing elements. Similarly, the end section of the sleeve is fixed to the wire end of the electrical conductor.

DE 11 2018 002 521 T5 similarly discloses such a method.

DE 10 2004 028 684 A1 and JP 2009-231004 A also disclose in each case a method for the automated fixing of a sleeve made of a flexible and electrically insulating material to a wire end of an electrical wire. For this purpose, the wire end of the electrical wire and an end section of an electrically insulating sleeve are introduced into a through opening provided in a mounting device and are fixed to each other there.

Such an approach has proven however to be particularly complex.

Therefore, exemplary embodiments of the present invention are directed to an improved method for electrically insulating the wire end of an electrical wire, which method in particular is suitable for being carried out in an automated manner. Furthermore, an improved mounting device for carrying out such a method is to be provided.

Therefore, the fundamental idea of the invention is to insert the wire end of an electrical conductor into a tubular electrically insulating sleeve made of a flexible material and then to permanently fix the sleeve to the wire end. This approach can be performed in a simple automated manner. This is preferably done by means of a mounting device according to the invention, in which the tubular sleeve can first be arranged and which enables subsequent insertion of the wire end into the interior of the sleeve. In this case, the mounting device is equipped with a through opening, through which the electrical wire can be introduced at one end and the sleeve can be introduced at the other end. By equipping the mounting device with a suitable fixing element, the sleeve can be held steady in the through opening of the mounting device, which significantly simplifies the insertion of the wire end into the interior of the sleeve. The mounting device also comprises a cutting tool, by means of which an end section of the sleeve can be separated from the remaining part of the sleeve, even before the wire end of the electric conductor is inserted into the sleeve. This allows a tape or continuous material to be used as the raw material for the sleeve. Furthermore, the mounting device according to the invention is equipped with an electrical heating device, which ensures the irrevocable permanent fixing of the sleeve to the wire end, for example by bonding the material of the electrical insulation to the wire end, i.e., by forming an integral bond between the wire end and the sleeve. The mentioned steps enable very simple electrical insulation of the wire end of the electrical conductor, so that in particular they are suitable for the automated mounting of the sleeve on the wire end.

The method according to the invention therefore is used for electrically insulating an electrically conductive wire end of an electrical wire, preferably in automated fashion. Specifically, the method according to the invention comprises at least five steps a) to e). In step a), a mounting device is provided, which has a base body having a through opening extending from a first to a second outer side of the base body. In step b), an end section of the sleeve is introduced via the first outer side into the through opening. Furthermore, in step b), this end section of the sleeve is fixed in the through opening by means of at least one fixing element. In a further step c), the end section fixed in step b) is separated from the remaining part of the sleeve of the mounting device by means of a cutting tool, so that it forms an electrical insulation for the wire end of the electrical conductor after the separation. In step d), the wire end of the wire is introduced via the second outer side of the base body into the through opening and the wire end is inserted into the interior of the tubular end section of the sleeve fixed in the through opening. In step e), the end section of the electrically insulating sleeve is then fixed to the wire end of the wire.

Expediently, the mentioned steps a) to e) can be carried out in alphabetical order. The order of individual method steps a) to e) can however also be changed, where appropriate.

In one preferred embodiment of the method according to the invention, the fixing takes place in step d) by heat-shrinking the end section of the sleeve by means of heating, in particular by means of a, preferably electrical, heating device of the mounting device. The frictional connection created in this manner proves to be permanently stable.

According to an advantageous further development, the fixing takes place in step d) by bonding the sleeve to the wire end, preferably by means of an adhesive provided on the inside of the end section of the tubular sleeve. The forming of such an adhesive bond can be realized in a simple manner, by wetting the end section of the tubular sleeve with a suitable adhesive on the inside, which can be superfluously heated in this manner with the aid of an electrical heating device provided in the mounting device. The integral bond created in this manner also proves to be permanently stable.

Particularly preferably, the fixing in step d) takes place by means of mechanical crimping of the end section of the sleeve with the wire end of the electrical wire. In this variation, the provision of an adhesive can be omitted, whereby the method according to the invention is further simplified.

According to an advantageous development of the method according to the invention, the latter comprises a step a0) at least preceding step a). According to step a0), the tubular sleeve is converted from a flat or/and folded geometric shape into a substantially round geometric shape. This allows the use of continuous material or a tape material as a raw material for the sleeve.

The invention also relates to a mounting device for fixing, preferably in an automated fashion, a tubular sleeve made of a flexible and electrically insulating to a wire end of an electrical wire, in particular while performing the method according to the invention presented above.

The mounting device according to the invention comprises a base body, which has a through opening, which is preferably elongate and extends in an axial direction, extending from a first to a second outer side, into which the wire end of the electrical wire and an end section of the sleeve can be introduced. The mounting device also comprises at least one fixing element for fixing the end section of the sleeve accommodated in the through opening. Furthermore, the mounting device comprises a, preferably electrical, heating device for heating the end section of the sleeve. Finally, the mounting device according to the invention comprises a cutting tool for separating the end section that is fixed in the through opening from the remainder of the sleeve.

In a preferred embodiment of the mounting device according to the invention, the latter comprises at least one air duct extending in the base body and opening into the through opening for fixing the tubular end section to a peripheral wall of the base body delimiting the through opening by creating a vacuum.

Particularly preferably, the through opening can open into the first outer side of the base body by means of a first mouth section and furthermore open into the second outer side of the base body by means of a second mouth section. In this variation, the through opening tapers away from the first or second outer side, in particular conically, in the region of the first or/and second mouth section to form an insertion aid for the wire end or the end section of the sleeve.

According to a further advantageous development, an abutment for positioning the end section of the sleeve, preferably axially, in the through opening can be designed in the region of the first mouth section. Particularly preferably, the abutment is formed by an undercut made in the base body.

Particularly preferably, the base body can be designed in two parts having a first and a second base body part. The two base body parts jointly surround the through opening. In this case, the second base body part is designed to be releasable from the first base body part at least in the region of the second outer side in order to remove the wire end having the end section of the sleeve fixed to the wire end from the through opening. This variation facilitates the removal of the conductor once the sleeve has been mounted on the wire end.

Further important features and advantages of the invention result from the dependent claims, the drawings and the associated figure description with reference to the drawings.

Preferred exemplary embodiments of the invention are represented in the drawings and are explained in more detail in the following description, where the same reference signs refer to identical or similar or functionally identical components.

### BRIEF DESCRIPTION OF THE DRAWING FIGURES

The figures show, in each case schematically:

FIG. 1 an example of a mounting device according to the invention,

FIGS. 2-5 snapshots of the mounting device of FIG. 1 illustrating different method steps of the method according to the invention.

### DETAILED DESCRIPTION

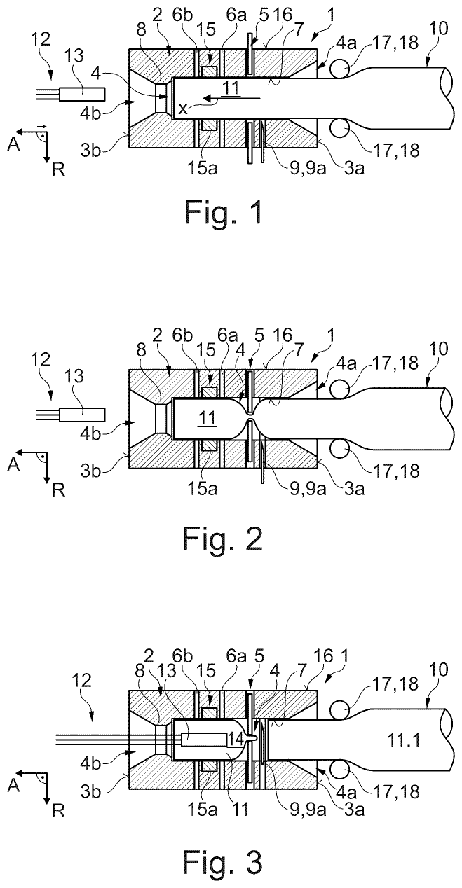

FIG. 1 shows by way of example and in a longitudinal section a mounting device 1 according to the invention for the automated fixing of a tubular sleeve 10 made of a flexible and electrically insulating material on a wire end 13 of an electrical wire 12. The electrical wire 12 can be formed by an electrical cable and furthermore be designed to be single core or multicore. The wire 12 can consist of an electrically conductive material, which in turn is surrounded on the outside by an electrically insulating material. In the example, the electrically conductive material is exposed at a wire end 13 of the wire 12 and therefore is to be electrically insulated with the aid of the method according to the invention and using a mounting device 1 according to the invention.

The mounting device 1 comprises a base body 2 for this purpose, which has an elongated through opening 4, extending along an axial direction A from a first outer side 3a to a second outer side 3b. In this case, the two outer sides 3a, 3b with regard to the axial direction A are each end faces of the elongated base body 2. An end section 11 of the sleeve 10 can be introduced into the through opening 4—via the first outer side 3a of the base body 2. Similarly, the wire end 13 of the electrical wire 12 can be introduced into the through opening 4—via the second outer side 3b of the base body 2.

According to FIG. 1, the mounting device 1 also comprises a fixing element 5, adjustable along a direction R perpendicular to the axial direction A, for fixing the end section 11 of the sleeve 10 accommodated in the through opening 4. Furthermore, the mounting device 1 comprises an electrical heating device 15 for heating the end section 11. For this purpose, the electrical heating device 15 can have an electrically heatable heating element 15a.

The mounting device 1 also comprises a cutting tool 9 for separating the fixed end section 11 from the remaining part of the sleeve 10, i.e., that part complementary to the end section 11. For this purpose, the cutting tool 9 can have an adjustable cutting blade 9a, which can be introduced into the through opening 4 along the direction R perpendicular to the axial direction A, so that it can cut the end section 11 of the sleeve 10 along the direction R.

Furthermore, in the example the mounting device 1 comprises two air ducts 6a, 6b extending in the base body 2 and each opening into the through opening 4. In the example scenario, the two air ducts 6a, 6b are arranged at a distance to each other with regard to the axial direction A and each extend orthogonally to the axial direction A, i.e., along the direction R. The two air ducts 6a, 6b can each be designed to be slit-shaped and in each case open into the through opening 4 at one end and open onto an outer surface 16 of the base body 2 at the other end. By means of the air present in these two air ducts 6a, 6b, a vacuum can be created for fixing the tubular end section 11 to a peripheral wall 7 of the base body 2 delimiting the through opening 4, by means of which vacuum the end section 11 is pressed against the peripheral wall 7.

Furthermore, as can be seen from FIG. 1, the through opening 4 opens into the first outer side 3a of the base body 2 by means of a first mouth section 4a and furthermore opens into the second outer side 3b of the base body 2 by means of a second mouth section 4b. In the example scenario, the through opening 4 tapers both in the region of the first as well as the second mouth section 4a, 4b away from the first outer side 3a and respectively second outer side 3b, in particular conically, in order to form an insertion aid for the wire end 13 or the end section 11 of the sleeve 10 in this manner. Furthermore, an abutment 8 for axially positioning the end section 11 of the sleeve 10 in the through opening 4 can be designed in the region of the second mouth section 4b. Expediently, this abutment 8 can be formed by an undercut made in the base body 2.

By means of the mounting device 1 described above, the method according to the invention can be carried out. The method according to the invention is described in the following by way of example with reference to FIGS. 1 to 5.

As explained above, the method according to the invention serves for electrically insulating an electrically conductive wire end 13 of an electrical wire 12, preferably in automated fashion. The method according to the invention comprises five obligatory steps a) to e) for this purpose.

Firstly, however, in an optional step a0) preceding these five obligatory steps, a tubular sleeve 10 provided as a tape material or continuous material can be converted from a folded and thus flat geometric shape into a substantially round geometric shape (not shown in the figures).

In step a) of the method according to the invention, the mounting device 1 shown in FIG. 1 is provided.

Then, as indicated in FIG. 1 with the aid of an arrow X, in step b) an end section 11 of the sleeve 10 made of an electrically insulating and flexible material—such material can be a suitable plastic—is introduced into the through opening 4 along the axial direction A via the first outer side 3a. The introduction can take place with a suitable transport device 17 of the mounting device 1, which has transport rollers 18 for transporting the sleeve 10 along the axial direction A for this purpose.

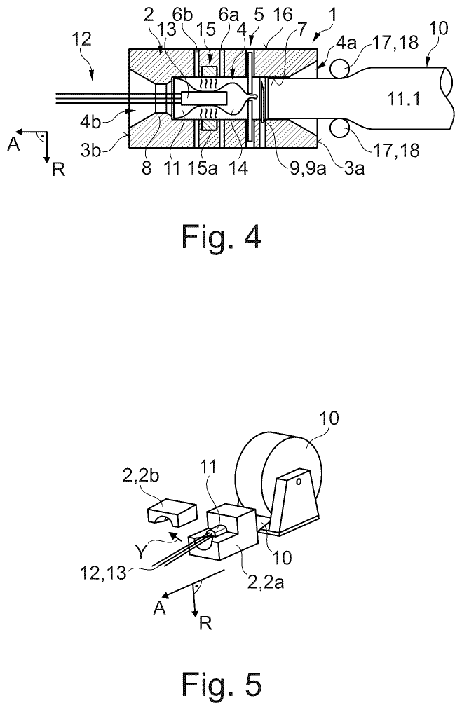

After it has been introduced into the through opening 4—similarly as a part of step b)—the end section 11 of the sleeve 10, as shown in FIG. 2, is mechanically fixed in the through opening 4 by means of an adjustable fixing element 5. For this purpose, the fixing element 5 presses along a direction R perpendicular to the axial direction A from the outside onto the end section 11 and compresses or crimps the latter. The end section 11 is therefore clamped in the through opening 4 by means of the fixing element 5, making movement of the end section 11 along the axial direction A impossible.

In a further step c), the end section 11 fixed in the through opening 4 in step b), as shown in FIG. 3, is separated from the remaining part 11.1 of the sleeve 10, i.e., that part complementary to the end section 11, by means of a cutting tool 9 of the mounting device 1. Such a cutting tool 9 can comprise a cutting blade 9a, which as shown in FIG. 3 cuts the end section 11 by being introduced into the through opening 4 along the direction R orthogonal to the axial direction A.

In accordance with the representation of FIG. 3, in a further step d), the wire end 13 of the wire 12 is introduced into the through opening 4 along the axial direction A via the second outer side 3b and is inserted into the interior 14 of the tubular end section 11 of the sleeve 10 fixed in the through opening 4. In this case, as explained above, by means of air present in the two air ducts 6a, 6b a vacuum can be created for fixing the end section 11 to the peripheral wall 7 of the base body 2 delimiting the through opening 4, by means of which vacuum the end section 11 is drawn against the peripheral wall 7. Therefore, the volume of the interior 14 of the sleeve is maximized, which facilitates the insertion of the wire end 13 into the end section 11.

In a further step e), the end section 11 of the sleeve 10 is then fixed to the wire end 13 of the wire 12. The fixing of the electrical sleeve 10 to the wire 12 can take place in a variety of ways. For instance, the fixing in step e), as indicated in FIG. 4, can take place by heat-shrinking the end section 11 of the sleeve 10 by heating the same with the aid of the electrical heating device 15 of the mounting device 1. Alternatively, it is also conceivable, however, that the fixing in step e) takes place by bonding the end section 11 of the sleeve 10 to the wire end 13. For this purpose, a suitable adhesive (not shown) can be provided on the inside of the end section 11 of the tubular sleeve 10. Such adhesive bond can also be formed by heating the adhesive by means of the electrical heating device 15. In a further variation, the fixing in step e) can take place by means of mechanical crimping of the end section 11 of the sleeve 10 to the wire end 13. Also, a combination of two or all three of the three variations presented above is conceivable.

As shown in FIG. 5 in a perspective representation, the base body 2 can be designed in two parts having a first and a second base body part 2a, 2b. The two base body parts 2a, 2b jointly surround the through opening 4. In this case, the second base body part 2b is designed to be releasable from the first base body part 2a at least in the region of the second outer side 3b in order to remove the wire end 13 having the end section 11 of the sleeve 10 fixed to the wire end 13 from the through opening 4. Such a release and removal of the second base body part 2b from the first base body part 2a (see arrow Y in FIG. 5) facilitates the removal of the wire end 13 having the end section 11 of the sleeve 10, previously fixed to this, as indicated in FIG. 5.

If the base body 2 is designed as a single piece, the wire end 13 having the former end section 11 can be pulled out axially from the through opening 4.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-10. (canceled)

11. A method for electrically insulating an electrically conductive wire end of an electrical wire, the method comprising:
a) providing a mounting device having a base body with a through opening extending from a first outer side of the mounting device to a second outer side of the mounting device;
b) introducing an end section of a tubular sleeve, made of a flexible and electrically insulating material, via the first outer side into the through opening and fixing the end section in the through opening by at least one fixing element;
c) separating the fixed end section from a remainder of the sleeve by a cutting tool of the mounting device;
d) introducing the wire end of the electrical wire via the second outer side into the through opening and inserting the wire end into an interior of the end section of the sleeve arranged in the through opening; and
e) fixing the end section of the sleeve to the electrically conductive wire end.

12. The method of claim 11, wherein the fixing in step e) comprises heat-shrinking the end section of the sleeve.

13. The method of claim 11, wherein the fixing in step e) comprises bonding the end section of the sleeve to the wire end.

14. The method of claim 11, wherein the fixing in step e) comprises mechanically crimping the end section of the sleeve with the electrically conductive wire end of the electrical wire.

15. The method of claim 11, further comprising:
a0) converting the tubular sleeve from a flat or folded geometric shape into a round geometric shape, wherein step a0) precedes step a).

16. A mounting device comprising:
a base body comprising a through opening extending from a first outer side of the base body to a second outer side of the base body, wherein the through opening is configured so that an electrically conductive wire end of an electrical wire and an end second of a sleeve are introducible into the base body via the through opening;
at least one adjustable fixing element configured to fix an end section of sleeve accommodated in the through opening;
an adjustable cutting tool configured to separate the fixed end section from a remaining material of the sleeve; and
a heating device configured to heat the end section of the sleeve,
wherein the mounting device is configured to fix the sleeve, made of a flexible and electrically insulating material, to the electrically conductive wire end of the electrical wire.

17. The mounting device of claim 16, further comprising:
at least one air duct extending in the base body and opening into the through opening, wherein the at least one air duct is configured to fix the end section of the sleeve to a peripheral wall of the base body delimiting the through opening by creating a vacuum.

18. The mounting device of claim 16, wherein
the through opening opens into the first outer side of the base body via a first mouth section of the base body and opens into the second outer side of the base body via a second mouth section of the base body, and
the through opening tapers away from the first outer side or second outer side in a region of the first mouth section or the second mouth section to form an insertion aid for the electrically conductive wire end or the end section of the sleeve.

19. The mounting device of claim 18, further comprising:
an abutment configured to position the end section of the sleeve in the through opening is arranged in a region of the first mouth section.

20. The mounting device of claim 16, wherein the base body comprises a first base body part and a second base body part jointly surrounding the through opening, wherein the second base body part is releasable from the first base body part at least in a region of the second outer side to remove the electrically insulating wire end having the end section of the sleeve fixed to the electrically insulating wire end from the through opening.
